(19) United States
(12) Patent Application Publication
(10) Pub. No.: US 2022/0113972 A1
(43) Pub. Date: Apr. 14, 2022

(54) MICROPROCESSOR, AND OPERATION METHOD THEREFOR

(71) Applicant: SONY GROUP CORPORATION, TOKYO (JP)

(72) Inventor: YUUICHI NAKAMURA, TOKYO (JP)

(21) Appl. No.: 17/428,711

(22) PCT Filed: Nov. 20, 2019
(86) PCT No.: PCT/JP2019/045385

§ 371 Date: Aug. 5, 2021

(30) Foreign Application Priority Data
Feb. 14, 2019 (JP) 2019-024937

(51) Int. Cl. G06F 9/30; G06F 9/22

(52) U.S. Cl. CPC G06F 9/30181; G06F 9/223

(57) ABSTRACT

A microprocessor that includes a plurality of instruction sets and has a reduced code size is provided.

A microprocessor includes a plurality of instruction sets and executes a program while switching instruction sets on the basis of an instruction set switching bit that is included in an instruction code having been read in and represents an instruction set that should be executed next at the time of execution of the program. Each instruction set includes a set of collected instruction codes that are to be used when each intermediate language instruction that is classified in accordance with a process content is executed. Then, for each instruction set, instruction sets that are possible to be selected and should be executed next are limited in an instruction code.

### TECHNICAL FIELD

The technology disclosed in the specification relates to a microprocessor that executes a program on the basis of instruction sets, and an operation method therefor.

### BACKGROUND ART

Microprocessors include instruction sets and can execute various types of program on the basis of the instruction sets. For example, a typical RISC (Reduced Instruction Set Computer) type microprocessor includes one instruction set with a predetermined bit width and executes a program by using the instruction set.

In addition, there is a proposal made about a microprocessor including a plurality of instruction sets (see Patent Document 1, for example). The microprocessor has a plurality of instruction spaces each including a plurality of instruction codes, and different instruction spaces include different instructions represented with the same instruction codes. The microprocessor is configured such that any one of the plurality of instruction spaces is selected in accordance with a switching instruction and realizes implementation of many instructions.

### CITATION LIST

### Patent Literature

### [PTL 1]

Japanese Patent Laid-open No. 2009-181312A

### SUMMARY

### Technical Problem

An object of the technology disclosed in the specification is to provide a microprocessor including a plurality of instruction sets, and an operation method therefor.

### Solution to Problem

A first aspect of the technology disclosed in the specification is a microprocessor, in which the microprocessor includes a plurality of instruction sets. The microprocessor executes a program while switching instruction sets on the basis of information included in an instruction code read in at time of execution of the program.

Each instruction set includes a set of collected instruction codes that are to be used when each intermediate language instruction that is classified in accordance with a process content is executed. Then, for each instruction set, instruction sets that is possible to be selected and should be executed next are limited in an instruction code.

In addition, a second aspect of the technology disclosed in the specification is an operation method of a microprocessor including a plurality of instruction sets, in which the microprocessor includes an instruction set selection register that retains information representing an instruction set that should be selected from the plurality of instruction sets, the operation method including a step of fetching an instruction code, a step of, by using an instruction set that is retained in the instruction set selection register and selected on the basis of the information, decoding information representing an instruction code and an instruction set that should be executed next, a step of setting the information in the instruction set selection register, and a step of executing a decoding result of the instruction code.

### Advantageous Effects of the Invention

The technology disclosed in the specification can provide a microprocessor that includes a plurality of instruction sets is capable of switching between the instruction sets in a program without using switching instructions, and can have a reduced code size, and an operation method therefor.

Note that the advantageous effects described in the specification are presented merely for illustration, and advantageous effects of the present invention are not limited to them. In addition, the present invention exhibits further additional advantageous effects in some cases, in addition to the advantageous effects described above.

Still other objects, features, and merits of the technology disclosed in the specification will become apparent from more detailed explanations based on embodiments, and attached figures mentioned below.

### BRIEF DESCRIPTION OF DRAWINGS

FIG. 1 is a figure depicting a flow until a program described in a high-level language is compiled, and executed at a CPU.

FIG. 2 is a figure depicting a result of expansion of a high-level language source code through an intermediate language representation source code to an assembly language source code.

FIG. 3 is a figure depicting correspondences between intermediate language instructions, and necessary instructions in an instruction set of a CPU.

FIG. 4 is a figure depicting correspondences between intermediate language instructions, and newly defined small instruction sets.

FIG. 5 is a figure depicting an example in which instructions for switching instruction sets are inserted at intermediate portions of a program.

FIG. 6 is a figure depicting an example in which instruction set selection bits are added in instruction codes.

FIG. 7 is a figure depicting an example of a plurality of instruction sets specialized in intermediate language instructions of a compiler.

FIG. 8 is a figure depicting an example of bit allocation to instruction codes in an instruction set 1.

FIG. 9 is a figure depicting a relation between next IS and values of an instruction set selection bit used in the instruction set 1.

FIG. 10 is a figure depicting an example of bit allocation to instruction codes in an instruction set 2.

FIG. 11 is a figure depicting a relation between next IS and values of an instruction set selection bit used in the instruction set 2.

FIG. 12 is a figure depicting an example of bit allocation to instruction codes in an instruction set 3.

FIG. 13 is a figure depicting a relation between next IS and values of an instruction set selection bit used in the instruction set 3.

FIG. 14 is a figure depicting an example of bit allocation to instruction codes in an instruction set 4.

FIG. 15 is a figure depicting a relation between next IS and values of an instruction set selection bit used in the instruction set 4.

FIG. 16 is a figure depicting an example of bit allocation to instruction codes in an instruction set 5.

FIG. 17 is a figure depicting a relation between next IS and values of an instruction set selection bit used in the instruction set 5.

FIG. 18 is a figure depicting an example of bit allocation to instruction codes in an instruction set 6.

FIG. 19 is a figure depicting a relation between next IS and values of an instruction set selection bit used in the instruction set 6.

FIG. 20 is a figure depicting an operation example of a CPU including a plurality of instruction sets.

FIG. 21 is a flowchart depicting a procedure in which the CPU depicted in FIG. 20 executes an instruction.

FIG. 22 is a figure depicting another operation example of a CPU including a plurality of instruction sets.

FIG. 23 is a figure depicting an internal configuration example of a composite instruction decoder 2201.

FIG. 24 is a flowchart depicting a procedure in which the CPU depicted in FIG. 22 executes an instruction.

FIG. 25 is a figure depicting an example of a source code of the C programming language.

FIG. 26 is a figure depicting an intermediate language representation obtained from the source code depicted in FIG. 25.

FIG. 27 is a figure depicting an assembly language (first half) obtained by performing code generation targeted at an RISC type CPU with 32-bit fixed length instructions from the intermediate language code depicted in FIG. 26.

FIG. 28 is a figure depicting the assembly language (second half) obtained by performing the code generation targeted at the RISC type CPU with 32-bit fixed length instructions from the intermediate language code depicted in FIG. 26.

FIG. 29 is a figure depicting a code (first half) obtained by performing code generation targeted at a CPU having multiple types of instruction set from the intermediate language code depicted in FIG. 26.

FIG. 30 is a figure depicting the code (second half) obtained by performing the code generation targeted at the CPU having multiple types of instruction set from the intermediate language code depicted in FIG. 26.

### DESCRIPTION OF EMBODIMENT

Hereinafter, embodiment of the technology disclosed in the specification are explained in detail with reference to the figures.

If a microprocessor includes many instruction sets, it is expected that many instruction codes can be implemented while still using a predetermined bit width, and the code size can be reduced. However, there is a problem that it becomes necessary to insert explicit switching instructions in order to perform switching between a plurality of instruction sets.

For example, in a case that a plurality of different tasks performs instruction execution by using different instruction sets, switching between instruction sets is necessary only when tasks are switched. Accordingly, it is not necessary to care about switching between instruction sets in a program that is executed in each task. In other words, it is not necessary to insert explicit switching instructions.

On the other hand, in a case where instructions of a plurality of instruction sets are executed in a program that operates on one task while switching between the plurality of instructions sets is performed, it is necessary to insert instructions for the switching every time it becomes necessary to do so, and frequent switching between instruction sets inevitably leads to an increase of the code size of the program even if the instruction sets themselves are small.

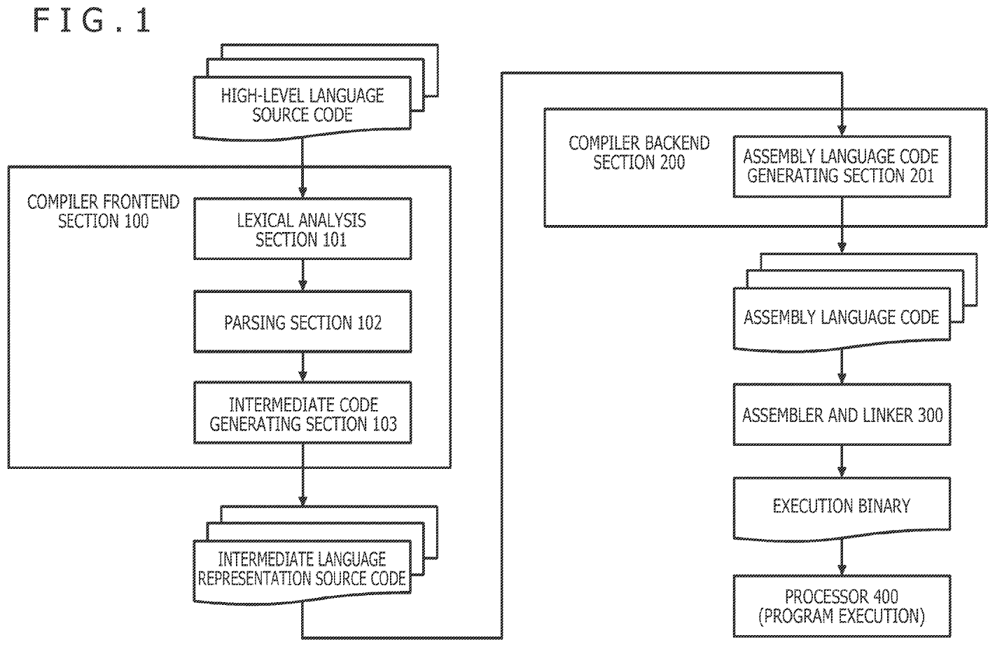

FIG. 1 schematically depicts a flow until a program described in a high-level language (e.g. the C programming language) is converted into an assembly language by a compiler, and an instruction code generated thereby is executed at a CPU (Central Processing Unit).

Functions of the compiler are roughly classified into a frontend section 100 and a backend section 200. In the compiler frontend section 100, lexical analysis by a lexical analysis section 101, and parsing by a parsing section 102 are performed on a source code of the input high-level language, and then an intermediate code generating section 103 temporarily converts the source code into an intermediate language representation that does not depend on the CPU. At the subsequent compiler backend section 200, using the source code represented in the intermediate language as an input, an assembly language code generating section 201 generates an assembly language code using an instruction set that depends on the target CPU.

Thereafter, the assembly language code is converted into a final execution binary by an assembler and linker 300. Then, it becomes possible for the target CPU (processor 400) to execute a program by an execution binary.

The intermediate language representation used at the intermediate code generating section 103 in FIG. 1 is in one of various formats according to the type of a compiler. Typically, a language that can represent block structures and data formats of a program described in a source code is defined, without being bound by an instruction set of a particular CPU. For example, LLVM IR (Intermediate Representation) that supports C++, Python, Golang, and OCaml as a default setting is known. LLVM IR can effectively represent a high-level language, and is independent of instruction set architectures (ISA) such as ARM, X86, X64, MIPS, or PPC.

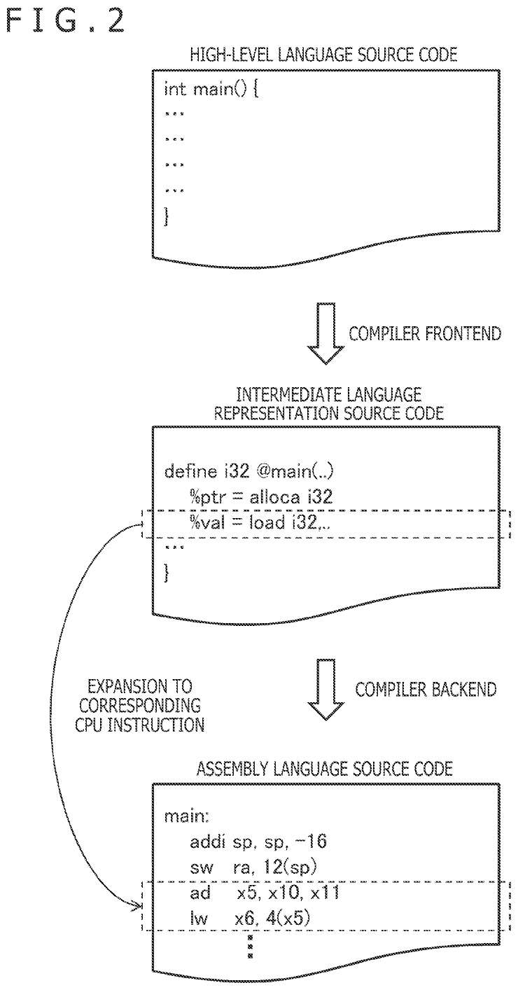

Each one of operations represented in the intermediate language is typically represented by using a plurality of instructions of the CPU. At the assembly language code generating section 201 of the compiler backend section 200, each instruction of the intermediate language is expanded into a plurality of corresponding CPU instruction codes. FIG. 2 depicts a result of conversion of a high-level language source code into an intermediate language representation source code at the compiler frontend section 100, and a result of expansion of the intermediate language representation source code into corresponding CPU instructions, and generation of an assembly language source code at the compiler backend section 200.

Typical CPUs each have a single instruction set. An RISC type CPU represents the whole of instructions included in the single instruction set by a 32-bit fixed length instruction code, for example. On the other hand, paying attention to intermediate languages used by compilers, CPU instructions necessary for realizing an intermediate language instruction are limited to a very small part of the whole of an instruction set provided in the CPU.

For example, load which is an intermediate language instruction is an instruction for reading out data of a particular member of a data structure (an array, a structure, etc.). This load instruction is examined.

% val=load i32,i32% array,i32% index [Math. 1]

In order to realize the load instruction at a CPU, it is considered that an add instruction or a shift instruction for computing a readout destination address, an instruction for reading out data in a particular data width from the computed address, and the like are necessary. On the other hand, a data write instruction, a branch instruction, a multiplication/division instruction, and the like are unnecessary.

In such a manner, it can be said that each intermediate language instruction prepared in an intermediate language used by a compiler (frontend) does not use all instructions included in an instruction set of a CPU uniformly but uses only some instructions.

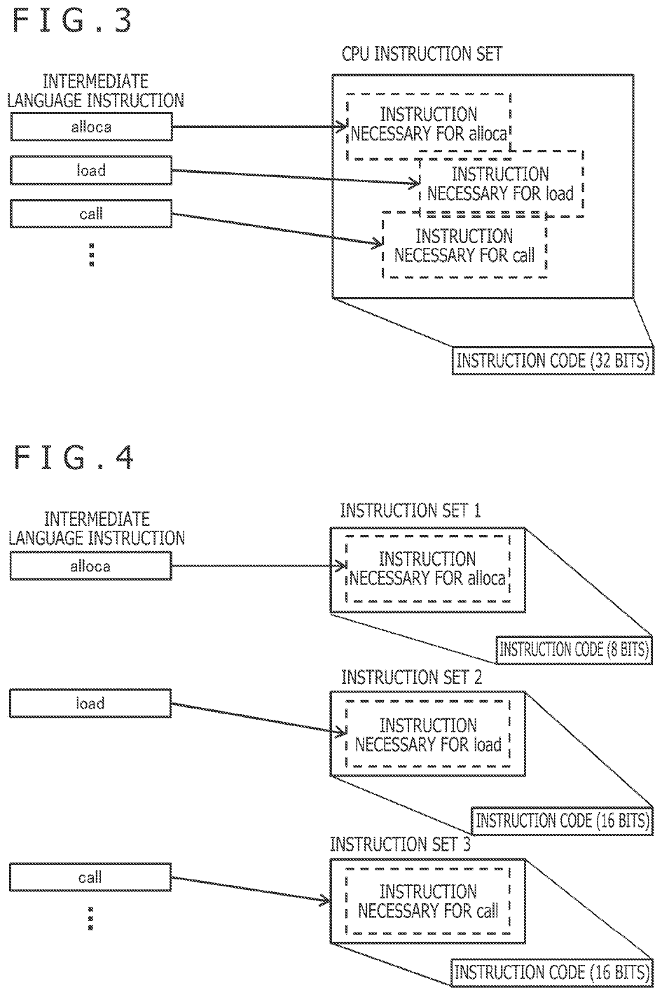

FIG. 3 schematically depicts correspondences between intermediate language instructions, and necessary instructions in an instruction set of a CPU. Examples of the intermediate language instruction include alloca, load, call, . . . , for example. In contrast to this, the CPU has a CPU instruction set including a set of instruction codes with a 32-bit length. Each instruction can include instruction codes up to 2³². However, each intermediate language instruction alloca, load, call, . . . does not use all the CPU instruction codes uniformly and can be realized by using some CPU instruction codes. FIG. 3 depicts a set of CPU instruction codes necessary for each of alloca, load, call, . . . .

In view of this, paying attention to the fact that each intermediate language instruction can be realized by using only some instruction codes in a CPU instruction set, in one possible case, only CPU instruction codes necessary for execution of each intermediate language instruction may be collected to newly define a small instruction set. Such a small instruction set can execute only some of processes that can be realized by the CPU, but instead can represent one instruction code by using a bit width (8 bits/16 bits/24 bits, etc.) smaller than a 32-bit fixed length.

FIG. 4 depicts correspondences between intermediate language instructions, and newly defined small instruction sets. An intermediate language instruction alloca corresponds to an instruction set 1 that is formed by collecting only CPU instruction codes that are necessary for execution of the instruction. In addition, an intermediate language instruction load corresponds to an instruction set 2 that is formed by collecting only CPU instruction codes that are necessary for execution of the instruction. In addition, an intermediate language instruction call corresponds to an instruction set 3 that is formed by collecting only CPU instruction codes that are necessary for execution of the instruction.

In such a manner, intermediate language instructions to be used by a compiler are classified into several groups, and a separate small instruction set is defined newly for each group. Then, when an assembly language code is generated from an intermediate language representation source code at the compiler backend section 200 (assembly language code generating section 201), a corresponding small instruction set is selected switchingly every time an intermediate language instruction appears in the intermediate language representation source code, and relevant instruction codes are output from the instruction set. Thereby, because the same process is realized with a code size which is smaller than that in a case that a single instruction set covering all the CPU instructions is used, it is possible to attempt to reduce the total code size.

However, it should be noted that instruction code patterns mean different instructions between different instruction sets even if the instruction code patterns are the same instruction code pattern. For example, in FIG. 4, instruction code patterns can mean different CPU instructions between the instruction set 1 and the instruction set 2 in some cases even if the instruction code patterns are the same instruction code pattern. Because of this, instructions of a plurality of instruction sets cannot be used simply in a form that they are mixedly present.

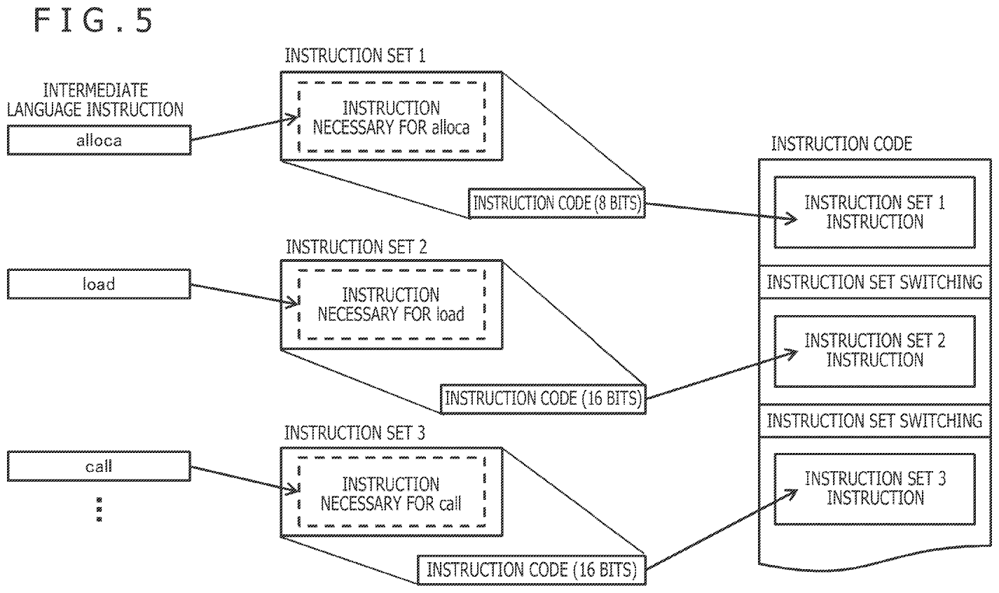

In order to solve this problem, instructions for switching instruction sets are inserted at intermediate portions of a program every time the instruction sets are switched. FIG. 5 depicts an example in which instructions for switching instruction sets are inserted at intermediate portions of a program.

In the example depicted in FIG. 5, intermediate language instructions appear in the order of alloca, load, call, . . . in an intermediate language representation source code. On the other hand, the CPU includes an instruction set 1 formed by collecting only instruction codes necessary for alloca, an instruction set 2 formed by collecting only instruction codes necessary for load, an instruction set 3 formed by collecting only instruction codes necessary for call, . . . .

Then, at the compiler backend section 200 (assembly language code generating section 201), a CPU-dependent assembly language source code is generated by replacing the alloca instruction in the intermediate language representation source code with an (8-bit long) instruction code included in the instruction set 1, and replacing similarly the load instruction with a (16-bit long) instruction code included in the instruction set 2, and the call instruction with a (16-bit long) instruction code included in the instruction set 3. Here, an instruction set switching instruction that gives an instruction about switching to the instruction set 2 is inserted between the instruction code of the instruction set 1, and the instruction code of the instruction set 2. Similarly, an instruction set switching instruction that gives an instruction about switching to the instruction set 3 is inserted between the instruction code of the instruction set 2 and the instruction code of the instruction set 3.

As described above, if an instruction for switching instruction sets is inserted at an intermediate portion of the program every time instruction sets are switched, the code size that has become small by using small instruction sets inevitably becomes large conversely by an amount corresponding to inserted instruction set switching instructions.

In view of this, the specification proposes a technology of suppressing an increase of the code size by adding information regarding each instruction set in an instruction code of the instruction set, instead of inserting instructions about switching between instruction sets as independent instructions. The information regarding the instruction set added in the instruction code specifically includes an instruction set selection bit representing an instruction set (next IS) that should be executed next. Thereby, selection of the next instruction set is performed in parallel with execution of an instruction, and so an increase of the code size due to insertion of explicit instruction set switching instructions can be avoided.

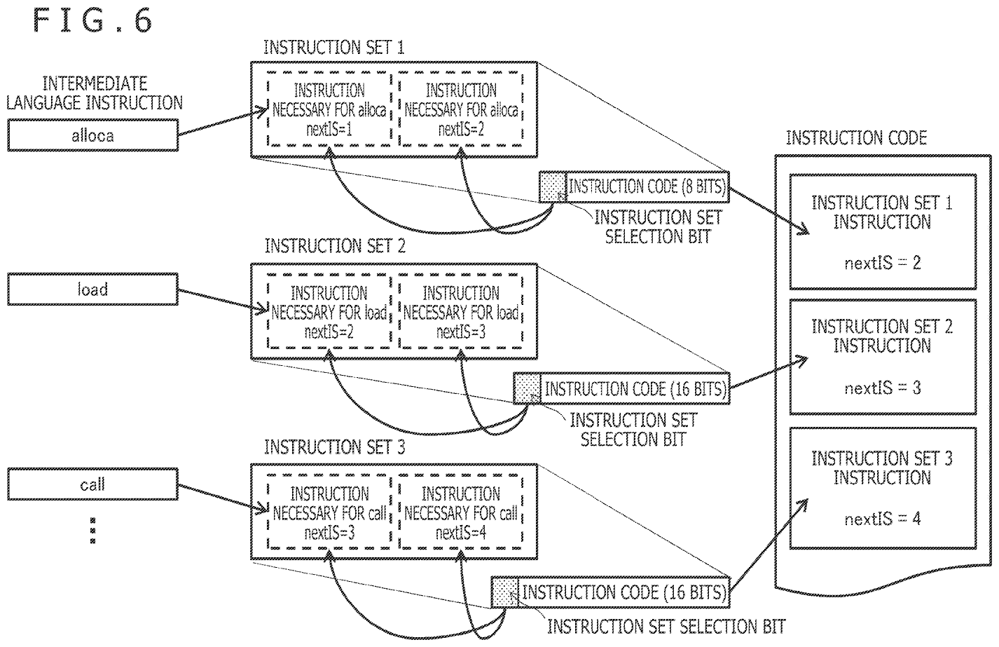

FIG. 6 depicts an example in which instruction set selection bits are added in instruction codes. In the example depicted in the figure, intermediate language instructions appear in the order of alloca, load, call, . . . in an intermediate language representation source code. On the other hand, the CPU includes an instruction set 1 formed by collecting only instruction codes necessary for alloca, an instruction set 2 formed by collecting only instruction codes necessary for load, an instruction set 3 formed by collecting only instruction codes necessary for call, . . . .

Here, the instruction set 1 includes instruction codes that are necessary for the alloca instruction, and include instruction set selection bits to specify the instruction set 1 and the instruction set 2, respectively, as instruction sets that should be executed next (i.e., next IS=1 and next IS=2). In addition, the instruction set 2 includes instruction codes that are necessary for the load instruction, and include instruction set selection bits to specify the instruction set 2 and the instruction set 3, respectively, as instruction sets that should be executed next (i.e., next IS=2 and next IS=3). In addition, the instruction set 3 includes instruction codes that are necessary for the call instruction, and include instruction set selection bits to specify the instruction set 3 and the instruction set 4, respectively, as instruction sets that should be executed next (i.e., next IS=3 and next IS=4).

Then, at the compiler backend section 200 (assembly language code generating section 201), the alloca instruction in the intermediate language representation source code is replaced with the instruction code in the instruction set 1 whose instruction set selection bit specifies the instruction set 2 (i.e., next IS=2). Similarly, the load instruction in the intermediate language representation source code is replaced with the instruction code in the instruction set 2 whose instruction set selection bit specifies the instruction set 3 (i.e., next IS=3), and the call instruction in the intermediate language representation source code is replaced with the instruction code in the instruction set 3 whose instruction set selection bit specifies the instruction set 4 (i.e., next IS=4).

In order for the CPU including a plurality of instruction sets to be able to select a certain instruction set from them in accordance with instruction set selection bits, a bit width that allows representation of the number of instruction sets is necessary for an instruction set selection bit. For example, in a case where the CPU includes eight types of instruction set, 3 bits (2³=8) are necessary for selection of instruction sets, and three instruction set selection bits have to be added to an original instruction code length (e.g. 8 bits/16 bits). There is a concern that if there is a wide selection of instruction sets, the bit width of instruction set selection bits increases by a corresponding amount, and the code size expands by the corresponding amount.

In view of this, in the technology proposed in the specification, it is attempted to reduce the bit width of instruction set selection bits by classifying intermediate language instructions of the compiler (compiler frontend section 100) into several groups, and allocating an instruction set to each group of the classified intermediate language instructions.

An intermediate language representation of the compiler includes instructions that are likely to be executed after an intermediate language instruction, and instructions that are unlikely to be executed after the intermediate language instruction. For example, if an intermediate language instruction to realize function call is executed, a function entrance process is executed necessarily at the called function, and so it is not necessary to consider switching to another instruction set. Furthermore, some process is performed, and then a function exit process is performed after the function entrance process, and so it is not necessary to consider switching to the function exit process immediately after the function entrance process.

In the technology proposed in the specification, instruction sets that are likely to be switched are treated as targets of instruction set switching by instruction set selection bits, and explicit instruction set switching instructions are inserted for only instruction sets that are unlikely to be switched. Thereby, the necessary bit width of instruction set selection bits is reduced. Then, the reduction can be allocated for specification of operands of instructions, or the like. Additionally, occasions in which instruction set switching instructions should be inserted are limited for instruction sets that are unlikely to be switched because the frequency of such switching is low (or because such switching is exceptional), and so an increase of the code size can be suppressed.

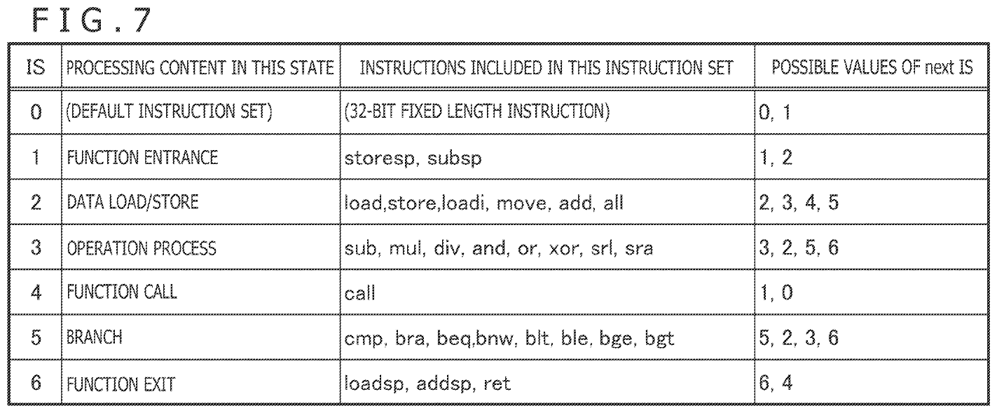

FIG. 7 depicts an example of a plurality of instruction sets specialized in intermediate language instructions of a compiler. In the example depicted in the figure, the CPU includes seven types of instruction set whose instruction set numbers (IS) are 0 to 6. Here, intermediate language instructions are classified on the basis of process contents (semantics). Alternatively, it can also be said that the intermediate language instructions are classified on the basis of the tendencies of instructions to be executed next. Hereinafter, each classification is explained in detail.

As the instruction set 0, a 32-bit fixed length instruction set is used as a default instruction set of the CPU. On the other hand, the instruction sets 1 to 6 are sets of instruction codes necessary for execution of processes to be performed in a program that correspond to intermediate language representations of the compiler, and classified into function entrance, data loading/storage, operation process, function call, branch, and function exit on the basis of process contents (semantics).

Specifically, the instruction set 1 includes instruction codes (storesp and subsp) necessary for realizing an intermediate language instruction having a process content (semantics) which is function entrance. In addition, the instruction set 2 includes instruction codes (load, store, loadi, move, add, sll) necessary for realizing intermediate language instructions having process contents which are data loading and data storage. In addition, the instruction set 3 includes instruction codes (sub, mul, div, and, or, xor, srl, sra) necessary for realizing an intermediate language instruction having a process content which is an operation process. In addition, the instruction set 4 includes an instruction code (call) necessary for realizing an intermediate language instruction having a process content which is function call. In addition, the instruction set 5 includes instruction codes (cmp, bra, beq, bne, blt, ble, bge, bgt) necessary for realizing an intermediate language instruction having a process content which is branch. In addition, the instruction set 6 includes instruction codes (loadsp, addsp, ret) necessary for realizing an intermediate language instruction having a process content which is function exit.

Then, the instruction sets 0 to 6 have different tendencies of instructions to be executed next. That is, each of the instruction sets 0 to 6 has determined instruction sets that can be selected as next instruction sets after instruction codes in the instruction set are executed, and those next instruction sets are described as possible values of next IS. Specifically, according to the description, the instruction set 0 and the instruction set 1 can be selected next to the instruction set 0, the instruction set 1 and the instruction set 2 can be selected next to the instruction set 1, the instruction set 2, the instruction set 3, the instruction set 4 and the instruction set 5 can be selected next to the instruction set 2, the instruction set 3, the instruction set 2, the instruction set 5 and the instruction set 6 can be selected next to the instruction set 3, the instruction set 1 and the instruction set 0 can be selected next to the instruction set 4, the instruction set 5, the instruction set 2, the instruction set 3 and the instruction set 6 can be selected next to the instruction set 5, and the instruction set 6 and the instruction set 4 can be selected next to the instruction set 6.

Specific examples are depicted below regarding in which case each of the instruction sets 1 to 6 listed as examples in FIG. 7 is used.

### Instruction Set 1 (Function Entrance)

The instruction set 1 is an instruction set including instructions necessary for processes like the ones mentioned below to be executed at the entrance of a called function.
Storage in a stack area of a register
Reserving a memory for a local variable area prepared on a stack

For these processes, the instruction set 1 includes the following instruction codes.
storesp (writing in data from a register to a stack area)
subsp (subtraction of a stack pointer)

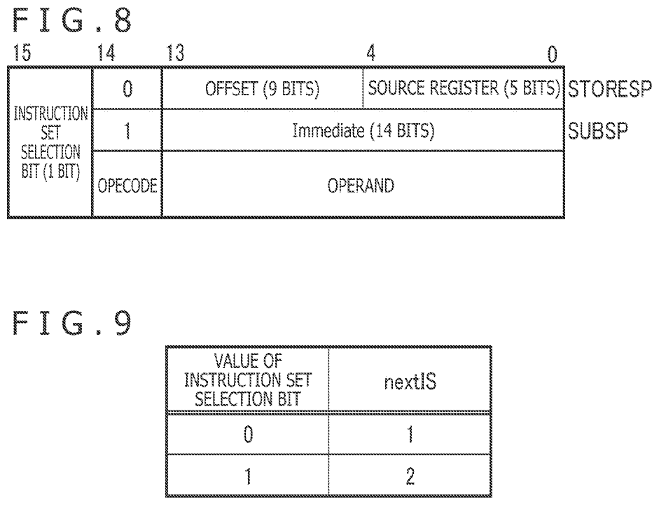

FIG. 8 depicts an example of bit allocation to the instruction codes in the instruction set 1. In addition, FIG. 9 depicts a relation between next IS and values of an instruction set selection bit used in the instruction set 1.

In a program, when the processes (storesp and subsp) described above for function entrance end, typically loading or storage of data that should be subjected to a process is to be performed. Because of this, the only possible values of next IS of the instruction codes included in the instruction set 1 are a value for continuous execution of the instruction set 1, and a value for switching to the instruction set 2.

### Instruction Set 2 (Data Loading/Storage)

The instruction set 2 is an instruction set including instructions necessary for a process of reading out or writing in data of a particular member with a data structure represented in a high-level language such as a variable, an array or a structure like the ones depicted below.
Reading out or writing in data from a given address to a register
Acquiring an array, and an address of corresponding a member from an index thereof
Acquiring a structure, and an address of a corresponding member from a member name thereof

For these processes, the instruction set 2 includes the following instruction codes.
load (reading out data from a memory to a register)
store (writing in data from a register to a memory)
loadi (assigning a constant value to a register)
move (moving data from a register to a register)
add (addition of a register and a register)
sll (a left shift of a register value)

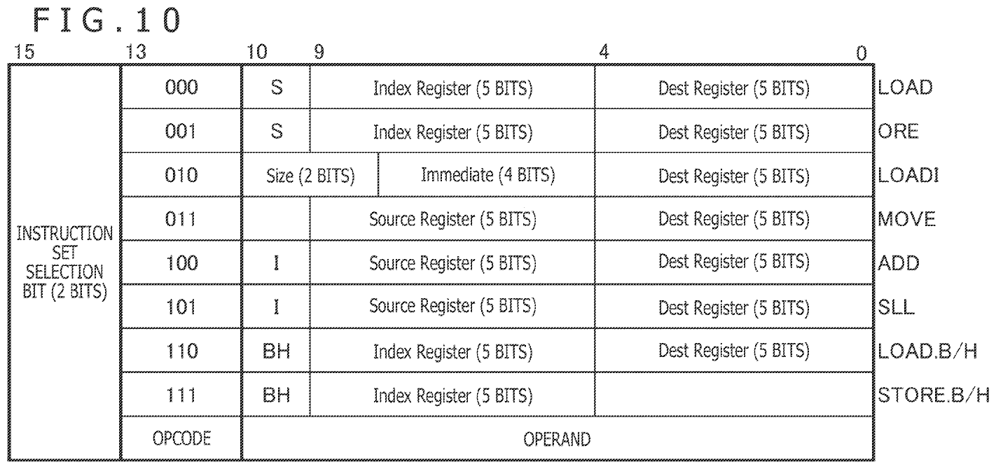

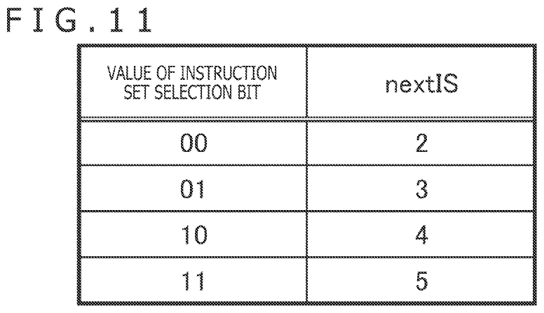

FIG. 10 depicts an example of bit allocation to the instruction codes in the instruction set 2. In addition, FIG. 11 depicts a relation between next IS and values of an instruction set selection bit used in the instruction set 2.

After the data loading or data storage is performed, an operation on the data, calling of another function or a conditional branch is to be performed. Because of this, as next IS of the instruction codes included in the instruction set 2, the instruction set 2 is to be executed continuously, or switching to any of the instruction sets 3, 4, and 5 is performed.

### Instruction Set 3 (Operation Process)

The instruction set 3 is an instruction set including instructions necessary for operation processes of performing operation formulae represented in a high-level language like the ones depicted below.
Four arithmetic operations (addition, subtraction, multiplication, and division) between a register and a register
Logical operations (and, or, xor) between a register and a register
Shift operations (right shift and left shift) between a register and a register

For these processes, the instruction set 3 includes the following instruction codes. However, it should be noted that addition and a left shift can be realized with the instruction set 2 (aforementioned), and so are not included in this instruction set 3.
sub/mul/div (four arithmetic operations between a register and a register)
and/or/xor (logical operations between a register and a register)
srl/sra (a right shift of a register value)

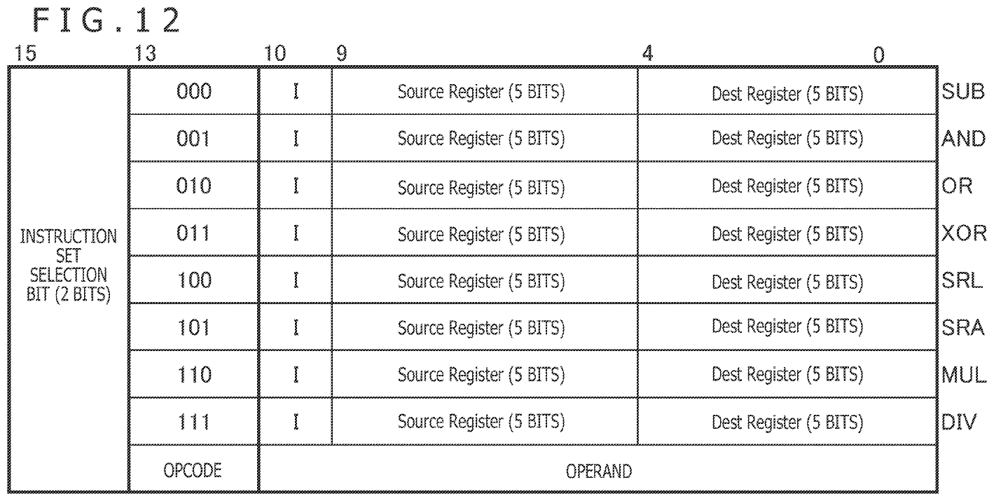

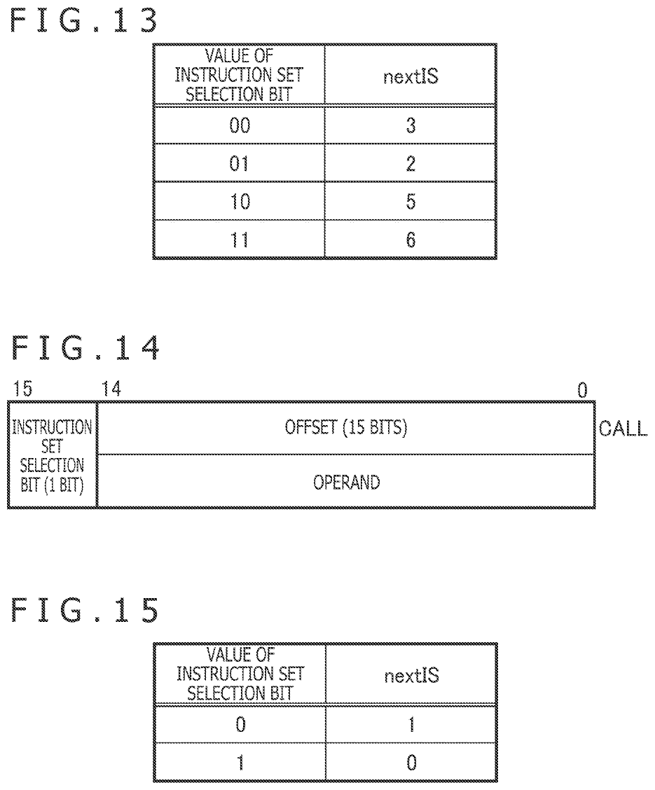

FIG. 12 depicts an example of bit allocation to the instruction codes in the instruction set 3. In addition, FIG. 13 depicts a relation between next IS and values of an instruction set selection bit used in the instruction set 3.

After an operation process is performed, storage of a result of the operation, loading of the next data, or a conditional branch is performed, or the process exits the function with the result of the operation returned from the function. Because of this, as next IS of the instruction codes included in the instruction set 3, the instruction set 3 is executed continuously, or switching to any of the instruction sets 2, 5, and 6 is performed.

### Instruction Set 4 (Function Call)

The instruction set 4 is an instruction set including only the following instruction necessary for calling another function from within a function.
call (calling a specified address)

FIG. 14 depicts an example of bit allocation to the instruction codes in the instruction set 4. In addition, FIG. 15 depicts a relation between next IS and values of an instruction set selection bit used in the instruction set 4.

If a function is called, the instruction to be executed at the called destination is necessarily function entrance. Because of this, it is only necessary to assume that possible next IS of the instruction code (call) included in the instruction set 4 is any of the instruction set 1, and the instruction set 0 for calling a function described in the default instruction set.

### Instruction Set 5 (Branch)

The instruction set 5 is an instruction set including instructions necessary for comparison between data, and a branch process according to a result of the comparison, like the ones depicted below.
Comparison of a magnitude relation between a register value and a register value
Branching according to a result of the comparison

For these processes, the instruction set 5 includes the following instruction codes.
cmp (comparison between values of a register and a register)
bra (unconditional branch)
beq/bne/blt/ble/bge/bgt (conditional branch according to a magnitude relation)

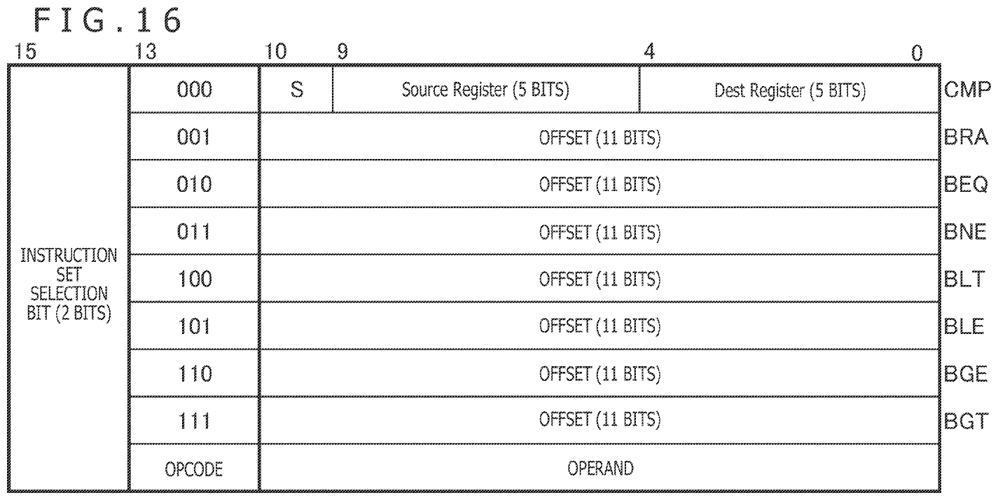

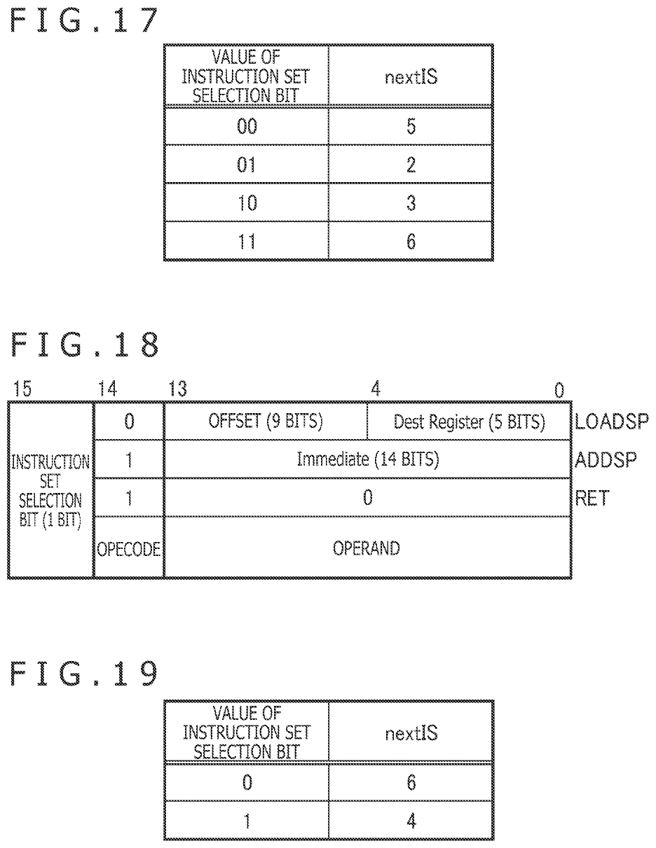

FIG. 16 depicts an example of bit allocation to the instruction codes in the instruction set 5. In addition, FIG. 17 depicts a relation between next IS and values of an instruction set selection bit used in the instruction set 5.

After branching is performed, data loading or data storage for the next operation, or an operation process are performed, or the process exits the function with the result of the operation returned from the function. Because of this, as next IS of the instruction codes included in the instruction set 5, the instruction set 5 is executed continuously, or switching to any of the instruction sets 2, 3, and 6 is performed.

### Instruction Set 6 (Function Exit)

The instruction set 6 is an instruction set including instructions necessary for processes like the ones mentioned below to be executed at the exit when a function ends.
Restoring a register value to a value stored in a stack area
Releasing a local variable area prepared on a stack
Branching into a return address of a function

For these processes, the instruction set 6 includes the following instruction codes.
loadsp (reading out data from a stack area to a register)
addsp (addition of a stack pointer)
ret (branching into a return address of a function)

FIG. 18 depicts an example of bit allocation to the instruction codes in the instruction set 6. In addition, FIG. 19 depicts a relation between next IS and values of an instruction set selection bit used in the instruction set 6.

After the function exit, the process necessarily returns to the caller. Because of this, the only possible values of next IS of the instruction codes included in the instruction set 6 are a value for continuous execution of the instruction set 6, and a value for switching to the instruction set 4.

In such a manner, the CPU allocates different instructions to the same instruction code pattern between different instruction sets.

Next, an operation example of operations of a CPU that includes a plurality of instruction sets like the ones mentioned above, and executes a program while performing switching between the instruction sets is explained.

### Operation Example 1

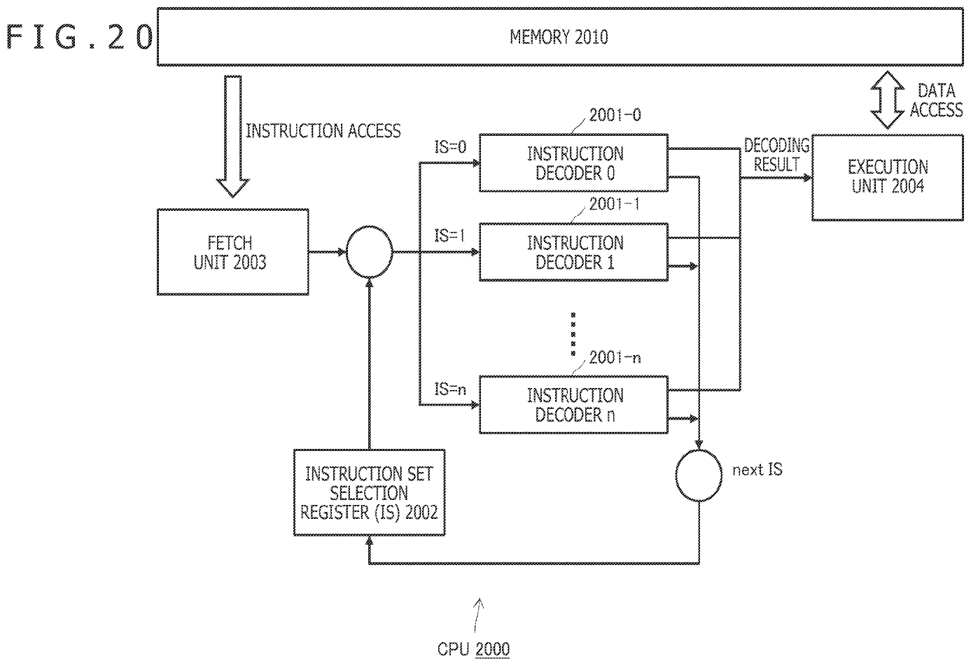

FIG. 20 depicts an operation example of a CPU including a plurality of instruction sets. A depicted CPU 2000 includes n types of instruction set 1 to n, in addition to an instruction set 0 which is a default instruction set. Then, the CPU 2000 includes a plurality of instruction decoders 0 to n represented by reference numerals 2001-0, . . . , and 2001-n for performing decoding processes corresponding to the instruction sets 0 to n, respectively. That is, the instruction decoders 2001-0, . . . , and 2001-n are instruction decoders corresponding to the instruction sets 0 to n, respectively.

A fetch unit 2003 accesses a memory 2010, and fetches an instruction code loaded onto the memory 2010. Then, the fetched instruction code is selectively allocated to an instruction decoder 2001 corresponding to an IS value retained in an instruction set selection register 2002. For example, when IS=0 is retained in the instruction set selection register 2002, the fetched instruction code is allocated to the zero-th instruction decoder 2001-0, and when IS=1 is retained in the instruction set selection register 2002, the fetched instruction code is allocated to the first instruction decoder 2001-1.

Each of the instruction decoders 2001-0, . . . , and 2001-n decodes an instruction code allocated to itself into a CPU instruction, and outputs the decoding result to an execution unit 2004.

The execution unit 2004 executes CPU instructions sequentially input from the instruction decoders 2001-0, . . . , and 2001-n. At that time, the execution unit 2004 executes the CPU instructions while accessing data (work data) temporarily stored on the memory 2010 as appropriate.

In addition, when the decoding process is performed, the instruction decoders 2001-0, . . . , and 2001-n output instruction set selection bits (next IS) included in the instruction codes. The instruction set selection bits are bit values representing instruction sets that should be executed next, and are retained in the instruction set selection register 2002 as IS (Instruction Set) values.

After being fetched from the memory 2010 by the fetch unit 2003, the next instruction code is selectively allocated to an instruction decoder 2001 corresponding to an IS value retained in the instruction set selection register 2002. At this time, the IS value is a value specified by an instruction set selection bit in an instruction code executed immediately before. Accordingly, selection of the next instruction set is performed in the CPU 2000 in parallel with execution of an instruction code. Then, selection of instruction sets is performed in turn appropriately without having to insert explicit instruction set switching instructions, and so an increase of the code size can be avoided.

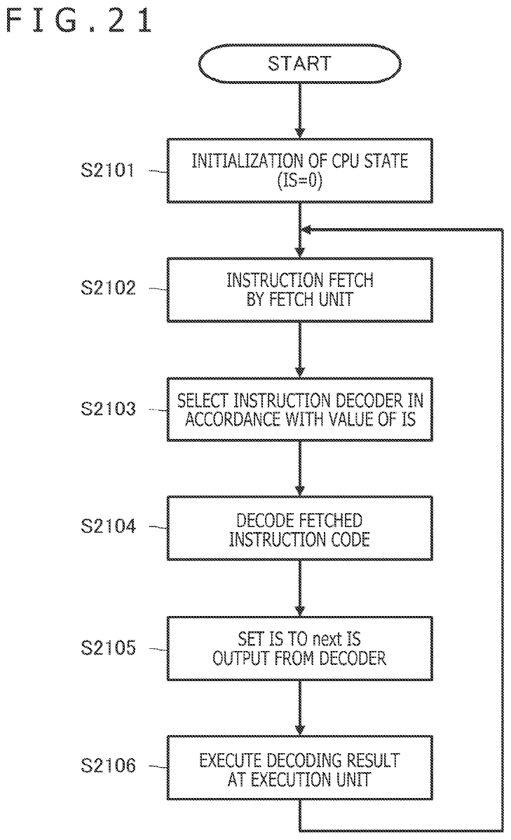

FIG. 21 depicts, in a flowchart format, a procedure in which the CPU depicted in FIG. 20 executes an instruction.

First, as the initial state of the CPU 2000, IS=0 (i.e., the default instruction set) is set in the instruction set selection register 2002 (Step S2101).

Next, in the CPU 2000, when the fetch unit 2003 fetches an instruction code from the memory 2010 (Step S2102), an instruction decoder is selected on the basis of an IS value retained in the instruction set selection register 2002 (Step S2103), and the fetched instruction code is allocated to the instruction decoder.

In a case where the instruction set selection register 2002 retains IS=k, the fetched instruction code is allocated to a k-th instruction decoder 2001-k (where k is a positive integer equal to or smaller than the number of instruction sets retained by the CPU 2000). Because IS=0 at first, the instruction code that has been fetched first is allocated to the zero-th instruction decoder 2001-0 that decodes the instruction set 0 which is the default instruction set.

The instruction decoder 2001-k decodes the instruction code allocated to itself into a CPU instruction (Step S2104). In addition, when the decoding process is performed, the instruction decoder 2001-k outputs an instruction set selection bit (next IS) included in the instruction code. Then, the instruction set selection bit is set as the IS value in the instruction set selection register 2002 (Step S2105).

The execution unit 2004 executes the CPU instruction input from the instruction decoder 2001-k (Step S2106). At that time, the execution unit 2004 executes the CPU instruction while accessing data (work data) temporarily stored on the memory 2010 as appropriate.

After the execution unit 2004 ends the execution of the CPU instruction, the process returns to Step S2102, and instruction code fetching, instruction decoder selection, instruction code decoding by selected instruction decoders, and instruction execution are performed repeatedly until the end of the program code is reached. At Step S2103, an instruction decoder is selected on the basis of an IS value that is specified by an instruction set selection bit in an instruction code executed immediately before (i.e., set at Step S2105 in the previous loop).

Because selection of the next instruction sets is performed in the CPU 2000 in parallel with execution of instruction codes, instruction sets can be selected appropriately without having to insert explicit instruction set switching instructions, and an increase of the code size can be avoided.

### Operation Example 2

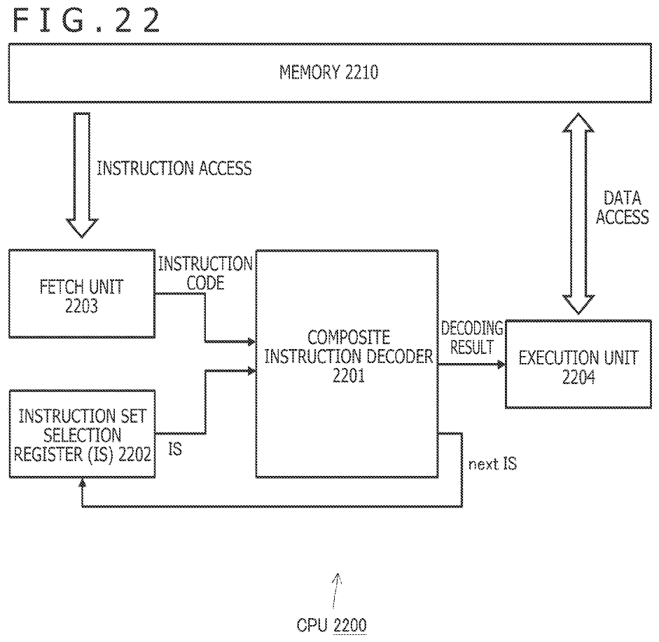

FIG. 22 depicts another operation example of a CPU including a plurality of instruction sets. The CPU 2000 depicted in FIG. 20 includes an instruction decoder for each instruction set. In contrast to this, a CPU 2200 depicted in FIG. 22 includes a single composite instruction decoder 2201 that can decode instruction codes of multiple types of instruction set.

A fetch unit 2203 accesses a memory 2210, fetches an instruction code loaded onto the memory 2210, and passes the instruction code over to the composite instruction decoder 2201. In addition, an instruction set selection register 2202 retains, as an IS value representing an instruction set that should be executed next, next IS output by the composite instruction decoder 2201 at the time of execution of the previous instruction code.

The instruction code provided from the fetch unit 2203 and the IS value retained in the instruction set selection register 2202 are input simultaneously to the composite instruction decoder 2201.

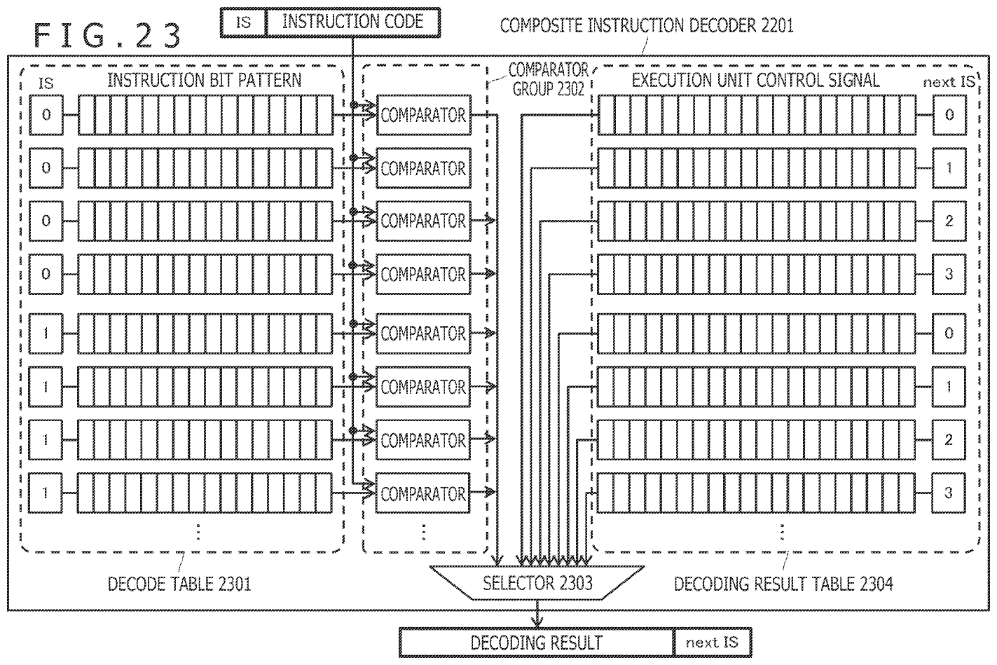

FIG. 23 depicts an internal configuration example of the composite instruction decoder 2201. The composite instruction decoder 2201 includes a decode table 2301, a comparator group 2302, a selector 2303, and a decoding result table 2304. The decode table 2301 retains, in each entry, a combination of an instruction set provided in the CPU 2200, and IS and an instruction bit pattern.

Each comparator in the comparator group 2302 compares an IS value and an instruction code input from the instruction set selection register 2202, and the fetch unit 2203 with a combination of an IS value and an instruction bit pattern retained in a corresponding entry in the decode table 2301. Then, a matching comparator inputs a match signal to the input terminal of the selector 2303.

In addition, the decoding result table 2304 retains, in each entry, a combination of next IS and an execution unit control signal to be used as a decoding result of an instruction code of each instruction set. A control signal output from each entry of the decoding result table 2304 is supplied to the input terminal of the selector 2303.

In a case where a match signal is output from the comparator group 2302, the selector 2303 selects and outputs a control signal matching an instruction code corresponding to a comparator that has output the match signal. That is, on the basis of the match signal output from the one comparator in the comparator group 2302, the selector 2303 selects one corresponding control signal from a plurality of control signals supplied from the decoding result table 2304, and outputs a decoding result and an instruction set selection bit (next IS).

An execution unit 2204 executes CPU instructions based on decoding results sequentially input from the composite instruction decoder 2201. At that time, the execution unit 2204 executes the CPU instructions while accessing data (work data) temporarily stored on the memory 2210 as appropriate.

In addition, instruction set selection bits output from the composite instruction decoder 2201 simultaneously with decoding results are bit values representing instruction sets that should be executed next, and are retained in the instruction set selection register 2202 as IS values.

Thereafter, after being fetched from the memory 2210 by the fetch unit 2203, the next instruction code is supplied to the composite instruction decoder 2201 simultaneously with an IS value retained in the instruction set selection register 2202. At this time, the IS value is a value specified by an instruction set selection bit in an instruction code executed immediately before. Accordingly, selection of the next instruction set is performed in the CPU 2200 in parallel with execution of an instruction code. Then, selection of instruction sets is performed in turn appropriately without having to insert explicit instruction set switching instructions, and so an increase of the code size can be avoided.

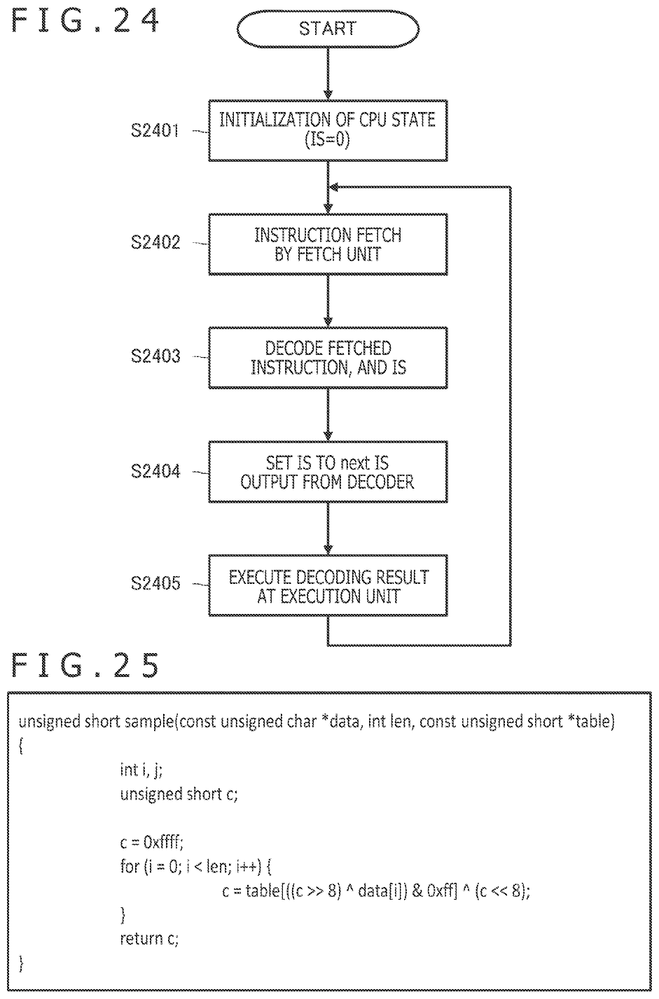

FIG. 24 depicts, in a flowchart format, a procedure in which the CPU depicted in FIG. 22 and FIG. 23 executes an instruction.

First, as the initial state of the CPU 2200, IS=0 (i.e., the default instruction set) is set in the instruction set selection register 2202 (Step S2401).

Next, in the CPU 2200, the fetch unit 2203 fetches an instruction code from the memory 2210 (Step S2402).

Next, the composite instruction decoder 2301 decodes the instruction code provided from the fetch unit 2203, and the IS value input from the instruction set selection register 2202 (Step S2403).

Then, the composite instruction decoder 2301 selects, from the decode table 2301, a control signal matching an instruction code corresponding to a combination of an IS value and an instruction bit pattern matching in the decode table 2301, outputs a decoding result and an instruction set selection bit (next IS), and sets the instruction set selection bit in the instruction set selection register 2202 (Step S2404).

The execution unit 2204 executes the CPU instruction input from the instruction decoder 2201 (Step S2405). At that time, the execution unit 2204 executes the CPU instruction while accessing data (work data) temporarily stored on the memory 2210 as appropriate.

After the execution unit 2204 ends the execution of the CPU instruction, the process returns to Step S2402, and instruction code fetching, instruction decoder selection, instruction code decoding by selected instruction decoders, and instruction execution are performed repeatedly until the end of the program code is reached. At Step S2403, a decoding result based on an IS value that is specified by an instruction set selection bit in an instruction code executed immediately before (i.e., set at Step S2403 in the previous loop) is selected.

Because selection of the next instruction sets is performed in the CPU 2200 in parallel with execution of instruction codes, instruction sets can be selected appropriately without having to insert explicit instruction set switching instructions, and an increase of the code size can be avoided.

Note that an intermediate language used in a compiler, a plurality of instruction sets specialized in instruction codes used for the intermediate language, instruction codes included in each instruction set, and bit allocation to the instruction codes that are explained in the specification, and the figures are merely examples. An actual intermediate language, instruction codes, and the like in the CPU can be changed depending on implementation, and the like. However, it should be noted that it is asked to understand well that rather than by providing all instruction codes flatly in an instruction set, by defining a plurality of instruction sets that are focused on instructions to be used in intermediate language representations used by compilers, and executing those instruction sets while switching between the instruction sets is performed, the code size can be reduced.

An example of an instruction representation that uses a typical instruction set, and an example of an instruction representation that uses switching between a plurality of instruction sets by applying the technology proposed in the specification in a case where a program described in a high-level language is executed in a CPU are depicted below.

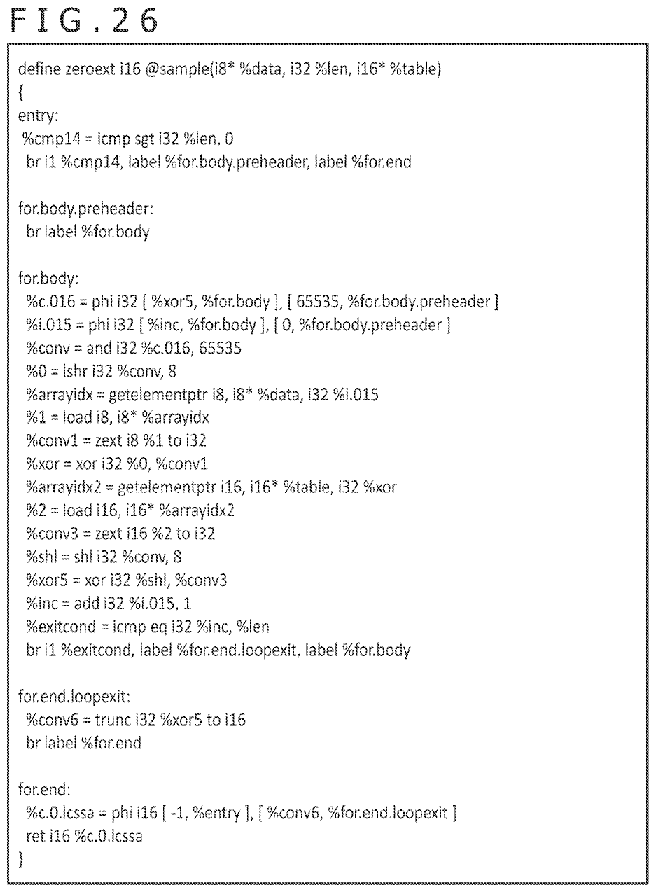

FIG. 25 depicts an example of a source code in the C programming language that is used as an input to a compiler. The compiler frontend section 100 outputs an intermediate language representation like the one depicted in FIG. 26.

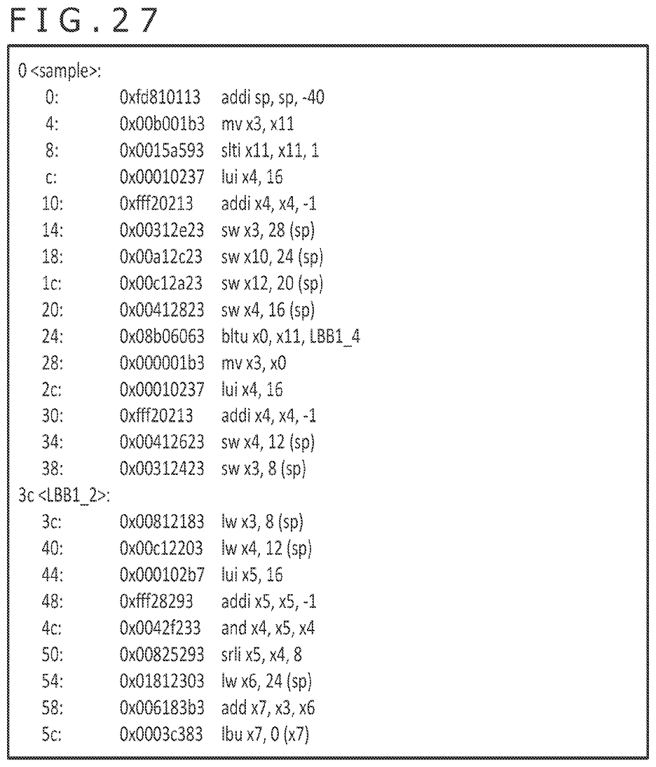

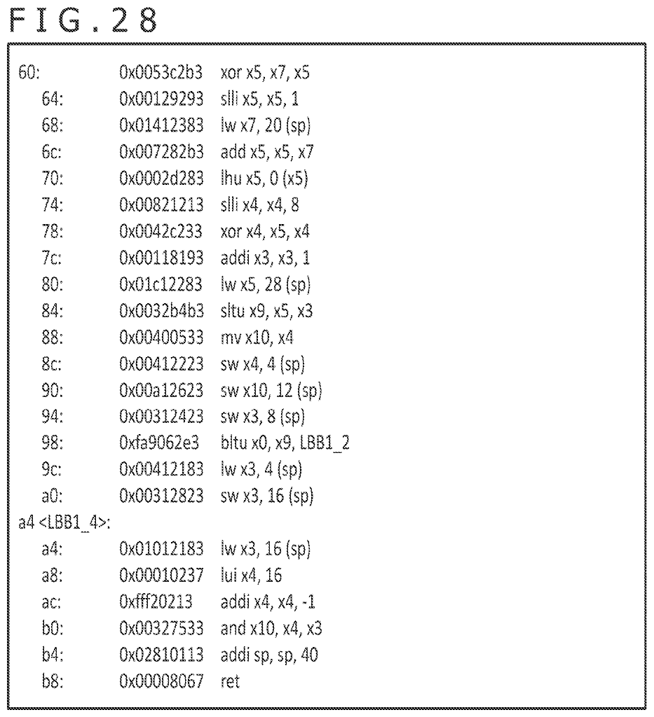

When code generation targeted at an RISC type CPU with 32-bit fixed length instructions is performed as in conventional technologies on the intermediate language code depicted in FIG. 26, an output of an assembly language like the one depicted in FIG. 27 and FIG. 28 is obtained. However, it should be noted that FIG. 27 depicts the first half of the output assembly language, and FIG. 28 depicts the second half of it.

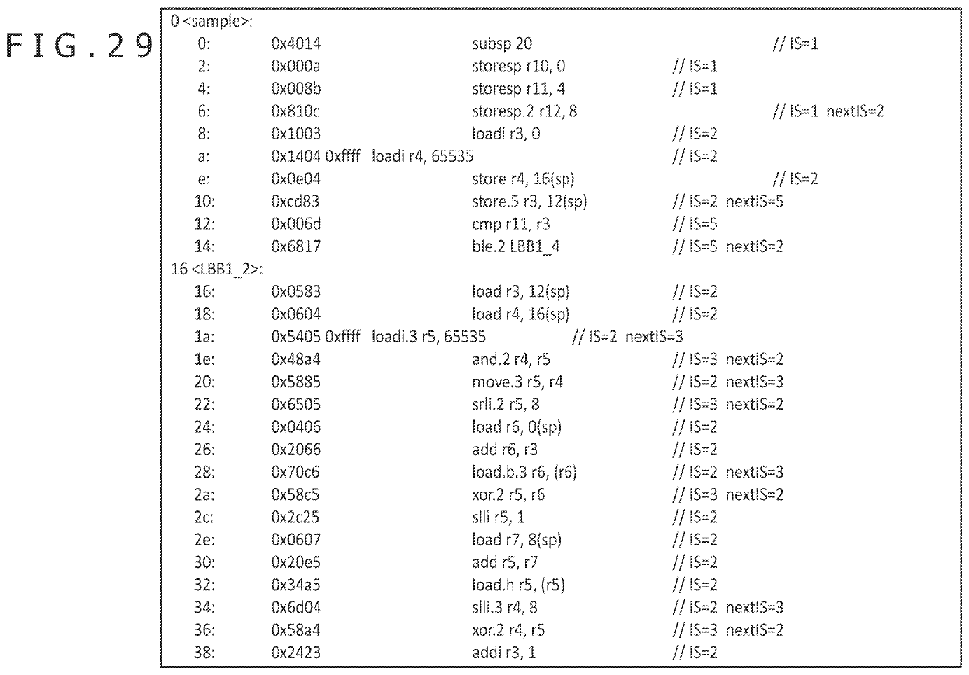

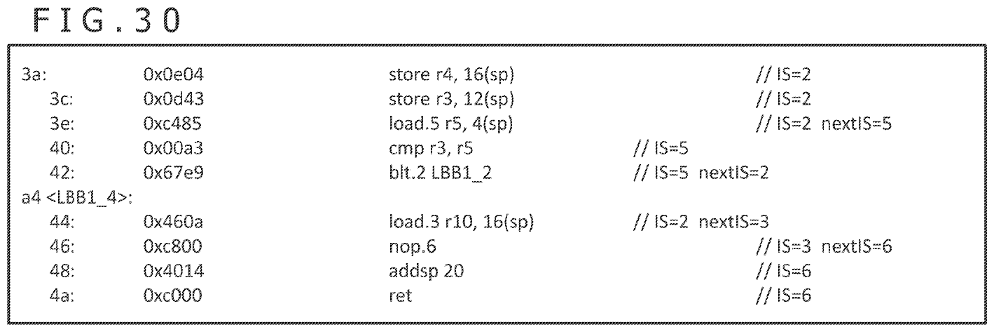

On the other hand, if code generation targeted at a CPU having multiple types of instruction set is performed on the intermediate language code depicted in FIG. 26, an output of a code like the one depicted in FIG. 29 and FIG. 30 is obtained. However, it should be noted that FIG. 29 depicts the first half of the generated code, and FIG. 30 depicts the second half of it.

In FIG. 29 and FIG. 30, in order to make it clear which instruction set each instruction code is executed as, the value of an instruction set selection register (IS), and the value of the next instruction set selection register (next IS) in a case where switching between instruction sets occurs as a result of the instruction are described as a comment at the end of the line.

In typical instruction execution, a value which is the same as that of the current IS is used as the next IS value, but in a case where switching between instruction sets is to be performed, a value specified as next IS is described after an opcode depicted below.

xor.2r5,r6 [Math. 2]

In such a manner, a case that code generation targeted at an RISC type CPU with 32-bit fixed length instructions is performed as in conventional technologies, and a case that code generation targeted at a CPU having multiple types of instruction set is performed are compared about instruction codes to be generated from the same program, code sizes differ as depicted in the following Table 1.

TABLE 1

| | Code size (hexadecimal | |
|---|---|---|
| CPU | number) | |
| RISC type CPU with 32-bit | 188 bytes | (o × bc) |
| fixed length instructions | | |
| CPU having multiple types | 76 bytes | (0 × 4c) |
| of instruction set | | |

Therefore, according to the technology proposed in the specification, in a case where the source code of the high-level language depicted in FIG. 25 is compiled, as compared with the case that code generation targeted at an RISC type CPU with 32-bit fixed length instructions is performed, it becomes possible to represent the same program with an instruction code size which is 76/199=approximately 40%. Therefore, by using a plurality of instruction sets in accordance with the technology proposed in the specification, it becomes possible to reduce the code size as compared with the case that a single instruction set is used.

### INDUSTRIAL APPLICABILITY

Thus far, the technology disclosed in the specification are explained in detail with reference to a particular embodiment. However, it is self-evident that those skilled in the art can make corrections to, or use substitutes in the embodiment within the scope not deviating from the gist of the technology disclosed in the specification.

The technology disclosed in the specification can be applied microprocessors implemented in various manners, and can reduce code sizes by defining a plurality of instruction sets focused on instructions that are used in intermediate language representations used by compilers, and executing the instructions while switching between the instruction sets is performed.

In summary, the technology disclosed in the specification has been explained in exemplary forms, and the description contents of the specification should not be interpreted in a limited manner. In order to determine the gist of the technology disclosed in the specification, the section of claims should be considered.

Note that the technology disclosed in the specification can have configuration like the ones mentioned below.

(1)

A microprocessor including:

a plurality of instruction sets, in which

the microprocessor executes a program while switching instruction sets on the basis of information included in an instruction code read in at time of execution of the program.

(2)

The microprocessor according to (1), in which the microprocessor executes switching between instruction sets on the basis of an instruction set switching bit that is included in an instruction code and represents an instruction set that should be executed next.

(3)

The microprocessor according to any of (1) and (2), in which each of the plurality of instruction sets corresponds to an instruction represented in an intermediate language used by a compiler.

(4)

The microprocessor according to any of (1) to (3), in which each instruction set includes a set of collected instruction codes that are to be used when each intermediate language instruction is executed.

(5)

The microprocessor according to (4), in which intermediate language instructions are classified into several groups, and an instruction set is allocated to each group of the classified intermediate language instructions.

(6)

The microprocessor according to (5), in which the intermediate language instructions are classified on the basis of contents of processes.

(6-1)

The microprocessor according to (6), in which the intermediate language instructions are classified into function entrance, data loading/storage, an operation process, function call, branch and function exit on the basis of contents of processes.

(7)

The microprocessor according to any of (5) and (6), in which the intermediate language instructions are classified on the basis of tendencies of instructions to be executed next.

(8)

The microprocessor according to any of (5) to (7), in which, for each instruction set, instruction sets that are possible to be selected and should be executed next are limited in an instruction code.

(9)

An operation method of a microprocessor including a plurality of instruction sets, the microprocessor including an instruction set selection register that retains information representing an instruction set that should be selected from the plurality of instruction sets, the operation method including:

a step of fetching an instruction code;

a step of, by using an instruction set that is retained in the instruction set selection register and selected on the basis of the information, decoding information representing an instruction code and an instruction set that should be executed next;

a step of setting the information in the instruction set selection register; and

a step of executing a decoding result of the instruction code.

### REFERENCE SIGNS LIST

100: Compiler frontend section
101: Lexical analysis section
102: Parsing section
103: Intermediate code generating section
200: Compiler backend section
201: Assembly language code generating section
300: Assembler and linker
400: Processor
2000: CPU
2001: Instruction decoder
2002: Instruction set selection register
2003: Fetch unit
2004: Execution unit
2200: CPU
2201: Composite instruction decoder
2202: Instruction set selection register
2203: Fetch unit
2204: Execution unit
2301: Decode table
2302: Comparator group
2303: Selector
2304: Decoding result table

1. A microprocessor comprising:
a plurality of instruction sets, wherein
the microprocessor executes a program while switching instruction sets on a basis of information included in an instruction code read in at time of execution of the program.

2. The microprocessor according to claim 1, wherein the microprocessor executes switching between instruction sets on a basis of an instruction set switching bit that is included in an instruction code and represents an instruction set that should be executed next.

3. The microprocessor according to claim 1, wherein each of the plurality of instruction sets corresponds to an instruction represented in an intermediate language used by a compiler.

4. The microprocessor according to claim 1, wherein each instruction set includes a set of collected instruction codes that are to be used when each intermediate language instruction is executed.

5. The microprocessor according to claim 4, wherein intermediate language instructions are classified into several groups, and an instruction set is allocated to each group of the classified intermediate language instructions.

6. The microprocessor according to claim 5, wherein the intermediate language instructions are classified on a basis of contents of processes.

7. The microprocessor according to claim 5, wherein the intermediate language instructions are classified on a basis of tendencies of instructions to be executed next.

8. The microprocessor according to claim 5, wherein, for each instruction set, instruction sets that are possible to be selected and should be executed next are limited in an instruction code.

9. An operation method of a microprocessor including a plurality of instruction sets, the microprocessor including an instruction set selection register that retains information representing an instruction set that should be selected from the plurality of instruction sets, the operation method comprising:
a step of fetching an instruction code;
a step of, by using an instruction set that is retained in the instruction set selection register and selected on a basis of the information, decoding information representing an instruction code and an instruction set that should be executed next;
a step of setting the information in the instruction set selection register; and
a step of executing a decoding result of the instruction code.
